(19) United States
(12) Patent Application Publication
(10) Pub. No.: US 2002/0142756 A1
(43) Pub. Date: Oct. 3, 2002

(54) Telephone answering system with courtesy greeting selectable after call is received

(76) Inventors: Joseph D. Rutledge, Mahopac, NY (US); Charles P. Tresser, New York, NY (US)

Correspondence Address: McGuire Woods LLP, Suite 1800, 1750 Tysons Boulevard, Tysons Corner, McLean, VA, 22102-3915, US

(21) Appl. No.: 09/824,580

(22) Filed: Apr. 3, 2001

(51) Int. Cl. H04M 11/10

(52) U.S. Cl. 455/412; 455/445; 455/458; 455/567

(57) ABSTRACT

A telephone answering system allows a recipient to spontaneously select a desired greeting after the phone has begun ringing to inform the caller that the call cannot be taken at this time and further providing an indication to either hold the line or when to expect a return call. A dedicated button is provided on the phone which, when pushed, selects a different greeting depending on the number of times the button is pushed. For example, if the recipient is interested in taking the call, but cannot at that particular instant, pressing the dedicated button one time will select a greeting like “Hold on a moment, I'll be right with you”. For n presses, the selected greeting might be “I'm sorry, I can't pick up the phone right now, but please leave your number and I'll call back in ((n-1)×10) minutes.” Knowing when they can expect a call back will increase the likelihood that the caller will make themselves available at the call back time and discourage phone tag.

### BACKGROUND OF THE INVENTION

1. Field of the Invention

The present invention generally relates to a telephone answering system and, more particularly, to a telephone answering system allowing the recipient to give the caller a spontaneously selected courtesy message without having to answer the telephone.

2. Description of the Related Art

Automated telephone answering systems have been common for several decades now. Probably the most familiar type is the answering machine that sits next to your home telephone and answers for you if you have not picked up within a predetermined number of rings, usually four. Early answering systems typically used magnetic tape to record a greeting message such as “You have reached 555-1234, we are sorry we can't come to the phone right now; please leave a message at the beep”. Usually a second magnetic tape was used to record the caller's message or the same greeting tape was used after fast-forwarding to a blank spot. In order to change the greeting, the previous greeting had to be recorded over (i.e., erased), and then recorded over again to change back to the general greeting. Therefore, the greeting message was rarely changed and often remained the same for years.

Magnetic tape answering machines are less common now as they have been replaced by digital machines. However, digital machines operate in much the same way as their magnetic predecessors except that the tape has been replaced by a digital memory that records greetings and messages on a chip. Some of the higher end machines have a feature that allows for multiple greeting messages that the user can select from prior to leaving the house. However, in daily practice this feature is rarely used since there is some effort involved.

Another type of common telephone answering system is commonly referred to as voice mail which replaces individual answering machines in favor of a central facility which monitors many subscriber lines. Voice mail is common in the business environment and cellular environment, as well as available to residential subscribers through their service provider for an additional monthly fee. Each subscriber has an assigned voice mail box located on a central server. When the voice mail system determines that the subscriber has not picked up for a number of rings or is already engaged in a previous conversation, the system plays the appropriate prerecorded greeting for the caller and gives the caller the option to leave a message which is stored in the designated voice mail box. The subscriber is then notified, either by a light on the subscriber's phone or by the voice mail system calling back at a later time indicating that one or more messages are available. The subscriber can then retrieve the messages through his phone, usually after entering a password into the phone's touch-tone keypad.

Voice mail systems are more sophisticated than home answering machines and can automatically select between two or more prerecorded greeting messages, depending on the situation. For example, the user can assign a general greeting such as the one mentioned above and can also designate a second greeting to be played when the subscriber's line is busy, such as “You have reached John Smith, I am in the office today but am currently taking another call, please leave a message at the tone.” The voice mail system may also have a time of day feature which selects yet another message to be played if a call is received after hours which informs the caller of normal business hours then places the caller directly into the voice mail box to leave a message.

The widespread use of automated answering systems has made playing “phone-tag” with your callers part of everyday life. That is, a caller calls you when your not available and leaves a message, you call them back when they are not available and leave a message, and so on and so on until both parties are eventually available for a live conversation. Playing this game can be frustrating, not to mention annoying for both parties.

A problem with all of the previously mentioned answering systems is that the system answers the phone and then automatically plays a designated greeting which may or may not give the caller an appropriate sense of the recipient's true intentions. Moreover, a recipient may not even have an answering system and therefore a caller may let the phone ring and ring or call back every few minutes which, of course is very annoying to the recipient and all those around.

For example, frequently a cell phone (or even a wired phone) may ring at a time when it is highly inconvenient to respond to it such as when the recipient is in a very noisy place, or involved in an activity which cannot be conveniently interrupted. In this case, the continued ringing of the phone may be disruptive but the user does not wish to miss the call, or bluntly refuse the call by immediately hanging up on the caller. If the answering system picks up, the recipient and those around will still have to endure a preselected number of rings, usually four before the answering system picks up the call. Thereafter, it will play a preselected greeting indicating that the recipient is not available. This begins the phone tag game. If, on the other hand, the caller does not have an answering system, the phone may continue to ring indefinitely until the caller hangs up or the phone is turned off; much to the annoyance of the recipient and those around.

### SUMMARY OF THE INVENTION

The present invention is directed to a telephone answering system which allows a user to spontaneously select a desired greeting after the phone has begun ringing. It allows the recipient to assure a caller that an incoming call is welcome, and will be responded to soon but not immediately, with little or no interruption of the recipient's immediate activities.

Unlike conventional answering systems which automatically select a greeting or require the user to preprogram the greeting prior to the phone ringing, a dedicated button or buttons are provided on the phone which, when pushed, select a different greeting depending on the number of times the button is pushed. For example, if the recipient is interested in taking the call, but cannot at that particular instant, pressing the dedicated button one time will select a greeting like “Hold on a moment, I'll be right with you”. This would discourage the caller from hanging up or leaving a message and thus prevent a phone tag situation. For n presses, the selected greeting might be “I'm sorry, I can't pick up the phone right now, but please leave your number and I'll call back in ((n-1)×10) minutes.” Thus, if the button is pushed twice, the caller will know to expect a call back in 10 minutes; 20 minutes for three pushes, 30 minutes for four pushes, and so forth. If Caller ID is functioning, the message might be “I'm sorry, I can't pick up the phone right now, but I'll call you back in ((n-1)×10) minutes at (number from Caller ID), or leave a message.”

Thus, the greeting can be spontaneously selected by the recipient to convey useful information to the caller to either hold the line or to inform them of when they can expect a call back. Knowing when a call back can be expected will increase the likelihood that the caller will make themselves available at the call back time. The present invention will in some cases eliminate phone tag or at least reduce the number of calls back and forth between the parties.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a view of an exemplary telephone receiver, and can represent a wired telephone, a cordless telephone, a mobile phone, or the like;

FIG. 2 is a block diagram showing an implementation of the present invention; and

FIG. 3 is a flow diagram illustrating the operational steps of the present invention.

### DETAILED DESCRIPTION OF A PREFERRED EMBODIMENT OF THE INVENTION

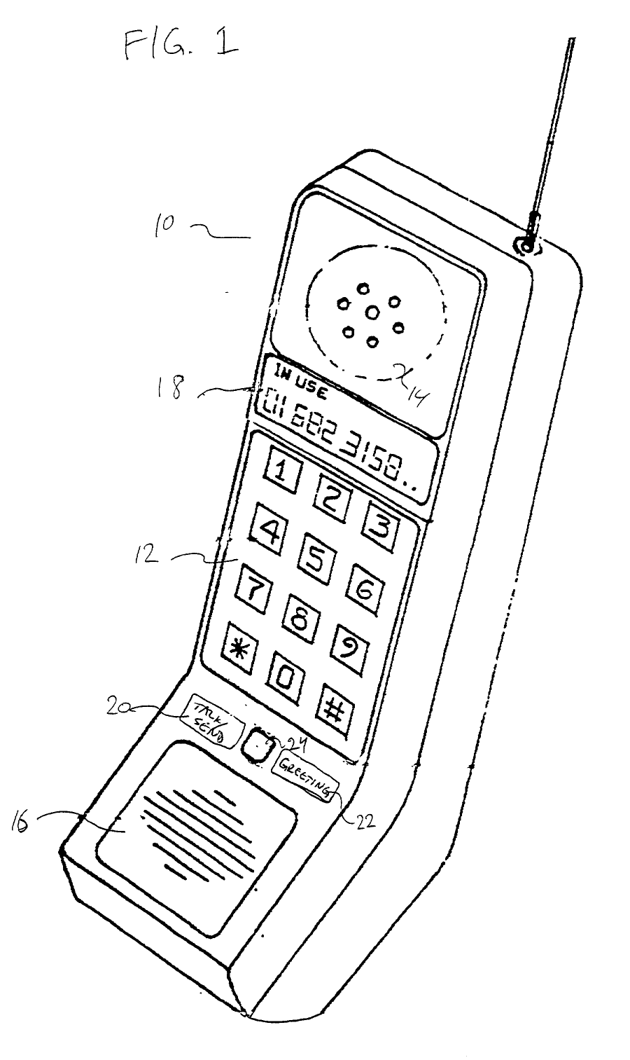

Referring now to the drawings, and more particularly to FIG. 1 there is shown a telephone 10 according to the present invention. The telephone of course can be of any type including a wired phone, portable wireless phone, mobile phone, cell phone, etc. The phone 10 typically includes a key pad 12, an ear piece 14, a microphone 16, and may include a display 18 for displaying information such as the “in use” status of the phone, the number dialed, Caller ID of an incoming call, elapsed call time, or a host of other available features. A talk/send button 20 is also provided for, in the case of portable or mobile phone, to take the phone off hook to answer a call or to transmit a dialed number to initiate a call.

In addition to the above features common to most phones, according to the present invention, a selective greeting button 22 is also provided. This can take the form of a single button which can be pressed a selected number of times to select different messages or may be more than one button, each for selecting a different greeting message. While this button has been shown as a separate button, it is understood that any one or more of the existing buttons on the phone key pad could also be designated to act as the greeting button.

In operation, when the phone 10 rings and the recipient is either unable or unwilling to immediately take the call, the recipient simply presses the greeting button and the caller receives a selected voice message (optionally in the recipient's recorded voice), corresponding to the number of presses. Preferably, after the button 22 is pressed, the ringing stops, even in the case when the greeting instructs the caller to hold the line and the call will be picked up shortly. A light 24 or other alert means may also be provided to remind the recipient of the holding call.

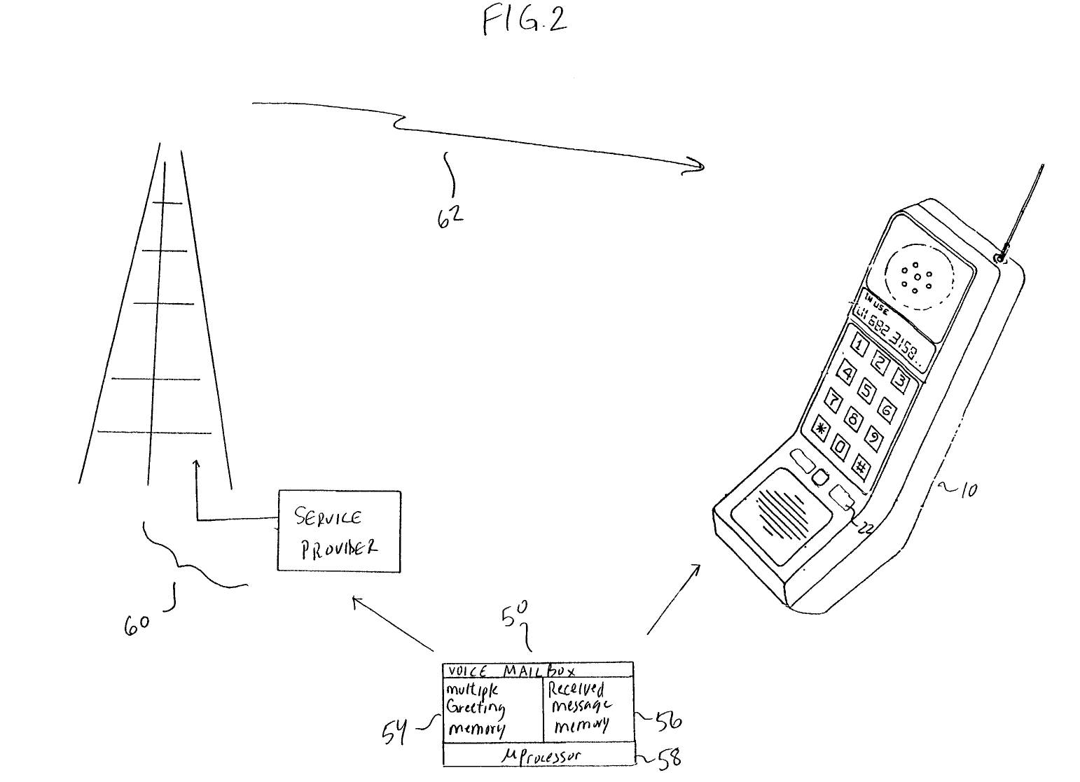

Referring to FIG. 2, there is shown a high level diagram showing the implementation of the present invention. A memory device operates as a voice mailbox 52 which has a section for storing multiple greetings 54 and a section for storing received messages 56 under the control of a microprocessor 58. In an alternate embodiment, the memory for storing multiple greetings 54 could be replaced by a voice synthesizer to synthesize multiple greetings rather than store them.

Still referring to FIG. 2, the functions of the present invention could be implemented locally by the recipient's phone 10 or may be carried out as an additional feature provided by a service provider 60. The service provider may of course be either a wired service provider or a wireless service provider, both designated by arrow 62. In either case the invention could be implemented in software stored in a computer readable medium for causing either the service provider's computers or the processor and memory in the telephone to implement the functions.

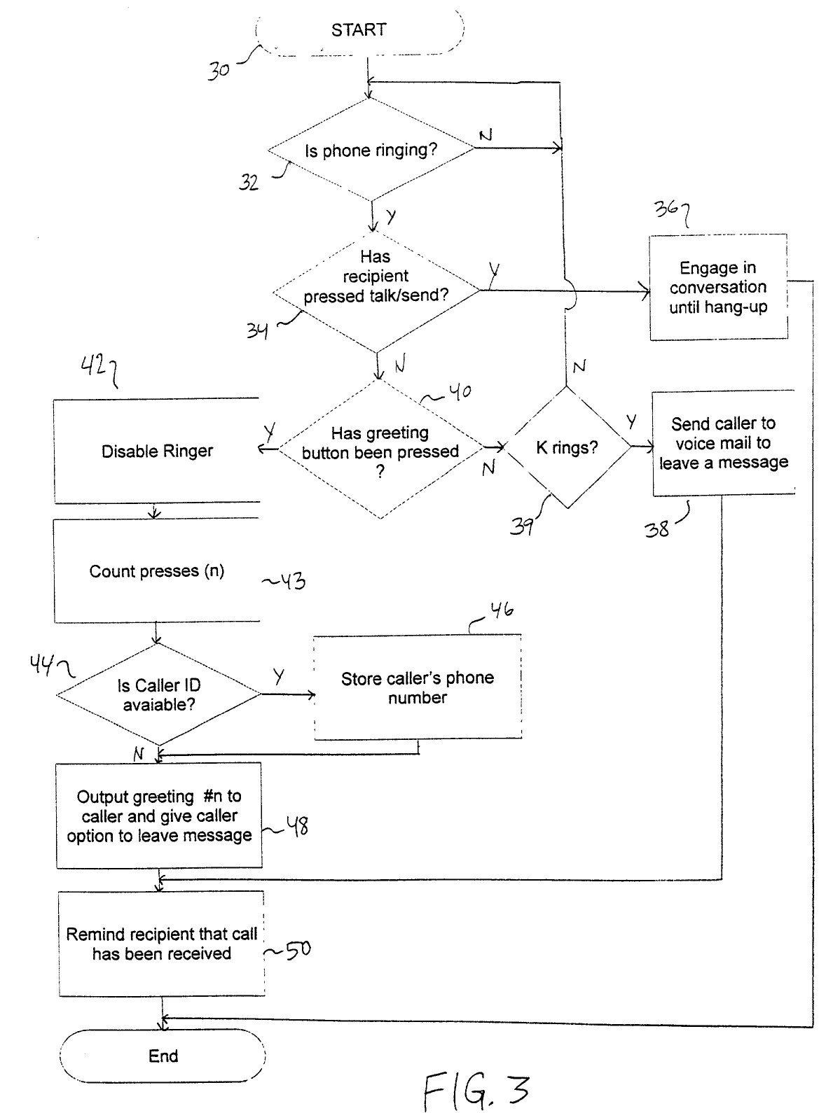

FIG. 3 is a flow diagram illustrating the operation of the device. At the start of the process at block 30 it is determined at decision box 32 whether or not the phone is ringing indicating an incoming call. If, at decision box 34 the recipient presses the talk/send button within a predetermined number of rings, usually four, a normal conversation is initiated at box 36 until either party hangs up. Rather than pressing the talk/send button, according to the invention, the recipient has the option to select a courtesy greeting informing the caller that they cannot take the call at this instant and informing the caller of the approximate time that they can expect a call back.

According to the invention, at decision box 40 it is determined if the greeting button has been pressed. At decision box 39, if neither the talk/send or the greeting buttons have been pressed after a predetermined number of rings (e.g. k=2 or 4 rings), this indicates that the recipient is truly unavailable and the system will answer the phone automatically with a standard or default greeting and give the caller the opportunity to leave a message as in a conventional answering system in box 38. If at decision box 40 the greeting button 22 has been pressed at least once the phone's ringer is stopped at box 42. The number of times the greeting button is pressed is counted in box 43 (i.e., 1 to n times). Optionally, in decision box 44 if Caller ID is available the caller's number is stored at box 46.

At box 48, if the recipient is interested in taking the call, but cannot at that particular instant, pressing the greeting button 22 one time will select a greeting like “Hold on a moment, I'll be right with you”. The system may at this time also give the caller the option to leave a message should the caller not wish to hold. For n presses the selected greeting might be “I'm sorry, I can't pick up the phone right now, but please leave your number and I'll call back in ((n-1)×10) minutes.” Thus, if the button is pushed twice, the caller will know to expect a call back in 10 minutes, three pushes would be 20 minutes, four pushes would be 30 minutes, and so forth. Thus, the selected greeting provides the caller with a time to expect a call back as a function of n. If Caller ID is functioning, the message may be modified to include the caller's number such as: “I'm sorry, I can't pick up the phone right now, but I'll call you back in ((n-1)×10) minutes at (number from Caller ID), or leave a message.” Of course these messages are for illustrative purposes and are preferably the default messages that the system will use. However, it will be appreciated that the recipient may designate or personalize the messages in any way that they wish. After a call has been received, but not immediately taken, at box 50 a reminder is provided that reminds the recipient that a call has been received or that a caller is holding. This reminder may take the form of a light, 24 somewhere on the phone, a message in the display screen 18, a periodic ringing of the phone with a distinctive sound, or any combination of the above. In the case of multiple received calls, data from each instance could be stored and displayed on the display 18 in a scroll-through fashion. This data may include, the Caller-ID number, the time of the call, and whether or not a message was left. Further, the reminder may provide an indication that a return call needs to be made to a particular party if a return call was not made within the time indicated in the selected message.

While the invention has been described in terms of a single preferred embodiment, those skilled in the art will recognize that the invention can be practiced with modification within the spirit and scope of the appended claims

We claim:

1. A selective call greeting system, comprising:
a telephone;
a means for producing n greetings where n is an integer of one or greater; and
means for selecting one of said n greetings after said telephone has begun to ring.

2. A selective call greeting system as recited in claim 1 further comprising means for stopping said telephone from ringing when said means for selecting is activated.

3. A selective call greeting system as recited in claim 1 wherein each of said n greetings comprise a message indicating a time when a call will be returned as a function on n.

4. A selective call greeting system as recited in claim 1 wherein a first of said n greetings comprises a message instructing a caller to hold.

5. A selective call greeting system allowing a recipient to select a greeting for a caller after a call has been received, comprising:
a telephone;
a means for producing a plurality of greetings;
a greeting button on said telephone for selecting one of said plurality of greetings after said telephone has begun to ring;
means for disabling a ringer on said telephone in response to said greeting button being pushed;
means for determining how many times said greeting button has been pushed; and
means for playing a selected greeting to the caller, said selected message corresponding to a number of times said greeting button was pushed.

6. A selective call greeting system allowing a recipient to select a greeting for a caller after a call has been received as recited in claim 5 wherein each of said plurality of greetings comprise an indication of a time when the call will be returned.

7. A selective call greeting system allowing a recipient to select a greeting for a caller after a call has been received as recited in claim 5 wherein said selected greeting comprises an indication of a time when the call will be returned as a function of said number of times said greeting button was pushed.

8. A selective call greeting system allowing a recipient to select a greeting for a caller after the call has been received as recited in claim 5 further comprising means for storing a caller's message.

9. A selective call greeting system allowing a recipient to select a greeting for a caller after a call has been received as recited in claim 5 further comprising:
an indicator on said telephone for reminding that a call has been received.

10. A method for spontaneously selecting a greeting to be played to a caller, comprising the steps of:
receiving a telephone call;
pushing a greeting button on said telephone after said telephone has begun to ring;
stopping said telephone from ringing;
counting a number of times, n, said greeting button is pressed; and
selecting a greeting to be played for a caller as a function of n, said selected greeting instructing the caller that the telephone call cannot be taken at this time and further containing information instructing the caller to hold or information regarding a time for a return call.

11. A method for spontaneously selecting a greeting to be played to a caller as recited in claim 10 further comprising the step of:
reminding that return call needs to be made to said caller if said return call has not been made within a time indicted by said selected greeting.

12. A method for spontaneously selecting a greeting to be played to a caller as recited in claim 10 further comprising the step of:
obtaining the caller's telephone number; and
including the caller's telephone number in said selected greeting.

13. A method for spontaneously selecting a greeting to be played to a caller as recited in claim 10 further comprising the step of:
offering the caller an option to leave a message; and
storing said message.

14. A computer readable medium comprising code for providing a telephone with a user selected greeting function, said code implementing the steps of:
designating a button on a telephone as a greeting button;
detecting a received telephone call;
stopping said telephone from ringing if said greeting button has been pressed after said telephone has begun to ring;
detecting a number n of times said greeting button was pressed on said telephone after said telephone has begun to ring; and
selecting a greeting to be played for a caller as a function of n, said selected greeting instructing the caller that the telephone call cannot be taken at this time and further containing information instructing the caller to hold or information regarding a time for a return call.

15. A computer readable medium comprising code for providing a telephone with a user selected greeting function as recited in claim 14, said code further comprising the step of:
reminding that return call needs to be made to said caller if said return call has not been made within a time indicted by said selected message.

16. A computer readable medium comprising code for providing a telephone with a user selected greeting function as recited in claim 14, said code further comprising the steps of:
obtaining the caller's telephone number; and
including the caller's telephone number in said selected greeting.

17. A computer readable medium comprising code for providing a telephone with a user selected greeting function as recited in claim 14, said code further comprising the steps of:
offering the caller an option to leave a message; and
storing said message.
